(19) United States
(12) Patent Application Publication
(10) Pub. No.: US 2008/0303263 A1
(43) Pub. Date: Dec. 11, 2008

(54) Book

(76) Inventor: Dan Blau, Winnetka, IL (US)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 11/758,405

(22) Filed: Jun. 5, 2007

(51) Int. Cl. B42D 1/00

(52) U.S. Cl. 281/15.1; 281/16

(57) ABSTRACT

A new book has a single fundamental element to be learned by the child (such as a single letter of the alphabet, or a single number, or a single color) on the front cover. The internal pages bear images associated with the element, such as words that are spelled with the letter, or images of products that have the color. Magnetically-attracting elements are included in both the spine of the book and a flap that is attached to a fore-edge side of one of the covers. These elements allow the books to be linked side-by-side. A collection of books can be offered as a set, with a separate book for substantially each of the letters of the alphabet. A child can link the books together to spell words.

### CROSS-REFERENCE TO RELATED APPLICATIONS

Not applicable.

### BACKGROUND OF THE INVENTION

The present invention relates generally to books, and more particularly to books that can be used to help children learn letters, numbers, and colors.

### BRIEF SUMMARY

The applicant has developed a new form of book. Like prior known books, the new book has internal pages that are positioned between front and back covers. A single “fundamental element” to be learned by the child, such as a single letter of the alphabet, or a single number, or a single color, or a single geometric shape, appears on the front cover. The internal pages bear images associated with the element, such as words that are spelled with the letter, or images of products that have the color.

Unlike prior known books, magnetically attracting elements are included in both the spine of the book and a flap that is attached to a fore-edge side of one of the covers. These elements allow the books to be linked side-by-side. When each book bears a letter, the child can link the books together to spell words.

Many variations are possible. For example, one of the images in the book can be a pictorial image of an object whose name is spelled using a letter on the front cover. Alternatively, one of the images could be a word that is spelled using that letter, with the letter appearing in an emphasized form over other letters used in the printed word. When a letter is used on the front cover, a collection of books can be offered as a set, with a separate book for substantially each of the letters of the alphabet.

When the cover bears a number, the pages of the book can be filled with pictorial images of groups of that number of objects. A collection of books can be offered that includes a separate book for substantially each integer from 1 to 9.

### BRIEF DESCRIPTION OF THE DRAWINGS

The invention may be better understood by referring to the accompanying drawings, in which:

FIG. 1 is a perspective view of a book that uses the invention.

FIG. 2 is a perspective view of the book seen in FIG. 1, opened to show an internal page.

FIG. 3 is a perspective view of a set of books that are magnetically linked together.

### DETAILED DESCRIPTION

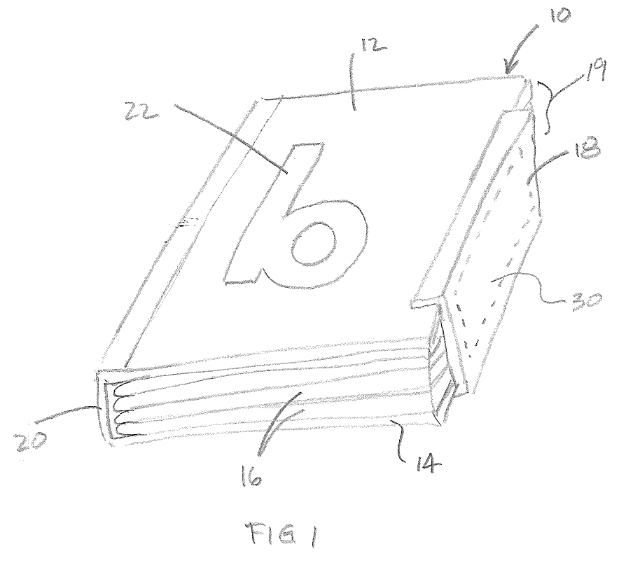

The book 10 that is seen in FIG. 1 has several primary components. It has a front cover 12, a back cover 14, and internal pages 16 that are positioned between the front cover and the back cover. A flap 18 is attached to a fore-edge side 19 of one of the covers. A spine 20 joins one edge of the front cover, one edge of the back cover, and one side of the internal pages. Each of these elements will be discussed in more detail below.

The front cover 12 bears a single fundamental element 22. If the fundamental element is a letter, as it is in the illustration, the letter could appear in either upper-case or lower-case form. The element appears in prominent form. Other visual elements could also appear on the cover, such as shapes or pictures, so long as they do not significantly detract from the visual prominence of the fundamental element.

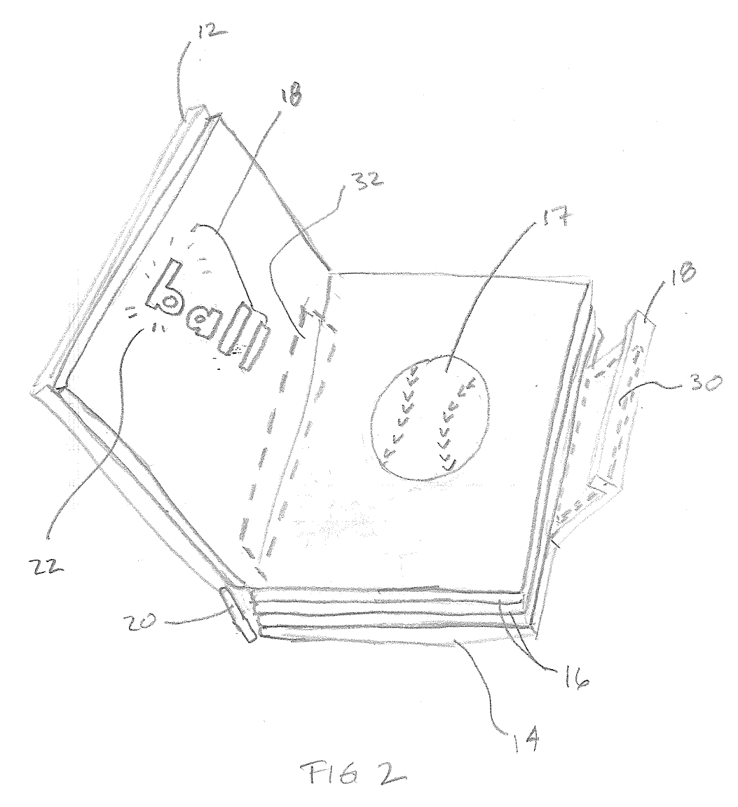

The internal pages 16 bear images that are associated with the fundamental element 22 that appears on the front cover 12. For example, as seen in FIG. 2, the internal pages 16 of the book in FIG. 1, which bears the letter “b” on the cover, include printed words that are spelled with the letter “b”. In this case, one page includes the word “ball” and another page might include the word “box.” In these cases, the letter “b” might appear in an emphasized form over the other letters used in the printed word, such as in bold type, underlined type, larger type, highlighted type, or brighter-colored type. Although the letter might appear at the start of the word printed on the page, it might also appear in the interior of the word or at the end of the word.

The pages 16 might also include pictorial images of an object whose name is spelled using the letter, such as an image 17 of a ball or a picture of a box when the cover bears the letter “b”. When an image is used, the image might be accompanied (either on the same page or on a facing page) by the written name 18 of the item, including the fundamental element that appears on the front cover of the book.

When the fundamental element is a number, the pages 16 can include pictorial images of groups of that number of objects. For example, if the fundamental element on the cover is the number “3”, then one page might include an image of a group of three marbles, while another page includes an image of a group of three crayons. The images might be photographs, electronic images, or drawings. In addition to the images, the pages might also bear the number itself.

When the fundamental element 22 is a color, the front cover 12 might bear either the color itself, the printed name of the color, or both. The pages 16 within that book might have pictorial images of objects that have that color. For example, if the fundamental element on the front cover is the color green, then one page inside the book might bear an image of a leaf, while another page bears the image of a grasshopper. The word “green” might also be printed on one or more of the pages.

When the fundamental element 22 is a shape, the pages 16 in the book might be objects that have that shape. For example, if the shape is a circle, the pages might include images of a pie, a clock, etc. If the shape is a triangle, the pages might bear images of a tent, a sailboat, etc.

While it is not essential that each of the pages 16 bear an image associated with the fundamental element, it is preferred that substantially all of the right-hand internal pages bear an image associated with that element. For example, if the pages are printed on one side only, then it might be preferred that substantially all of the printed pages bear an image associated with the element on the cover of the book.

The back cover 14 of the book can be plain. Alternatively, it could bear a fundamental element that is the same as or different than the fundamental element on the front cover. For example, if one cover of the book bears an upper-case “B”, then the opposite cover could bear a lower-case “b”. Alternatively, it could bear an entirely different fundamental element, and serve essentially as a front cover for a conceptually different “book” that uses the opposite sides of the pages that bear the images associated with the fundamental element on the opposite cover.

The flap 18 can be connected to either the front cover 12 or the back cover 14 of the book, and can sometimes be arranged so that it can be used to hold the book closed. For example, snaps or Velcro could be used. Preferably, the flap is at least long enough to cover the entire thickness of the fore-edge of the book. The flap need not extend the full height of the book, but could.

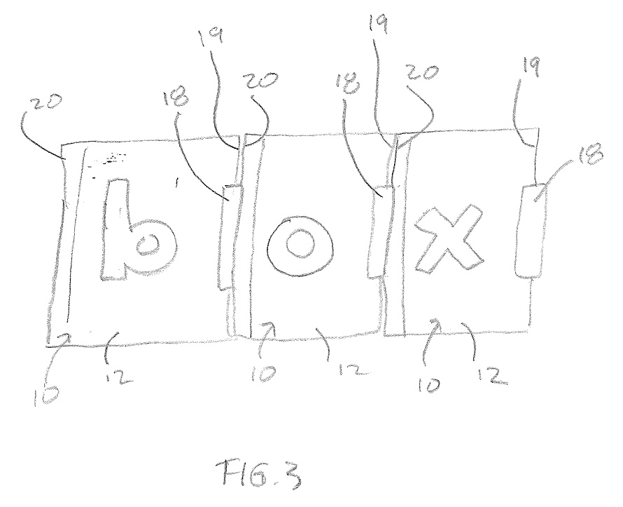

The flap 18 serves another more-important purpose. It contains one of two magnetically attracting elements 30, 32 indicated in FIG. 2. These elements can be two magnets or a magnet and a piece of metal that is attracted to magnets. While one of the elements is contained in or embodies the flap, the other element is contained in or embodies the spine 20 of the book. When the spine or flap is made of layers of paper or similar material, the magnetically attractive material can be interposed between layers. Together, the two magnetically attractive elements enable two books to hold together in a side-by-side relationship with the spine of one book adjacent the fore-edge of the other book, as seen in FIG. 3.

The ability of the magnetically attractive elements to hold the books together side-by-side can enable a child to arrange the books in sequence. If the front covers 12 of the books 10 bear letters, for example, the child might be able to arrange the books to spell a word. If the covers bear numbers, the child might be able to arrange the numbers in numerical order. If the covers bear colors, the child might be able to arrange the colors in a sequence such as the sequence of the colors in a rainbow.

To facilitate these kinds of arrangements, when a collection of books 10 includes books with letters on the front covers 12, a separate book might be provided for substantially each of the letters of the alphabet. Of course, some letters might be omitted, and some books might have a cover that bears a short letter combination, such as “th” or “qu.” Similarly, when a collection of books includes books with numbers on the front covers, a separate book might be provided for substantially each integer from 1 to 9. When a collection of books includes books with colors on the front covers, the collection might include a separate book for at least three different colors, such as the three primary colors.

This description of various embodiments of the invention has been provided for illustrative purposes. Revisions or modifications may be apparent to those of ordinary skill in the art without departing from the invention. The full scope of the invention is set forth in the following claims.

1. A book that has:
a front cover that bears a single fundamental element;
a back cover;
internal pages that are positioned between the front cover and the back cover and bear images associated with the element on the cover;
a spine that joins one edge of the front cover, one edge of the back cover, and one edge of the internal pages;
a flap that is attached to a fore-edge side of one of the covers; and
magnetically attracting elements in both the spine and the flap.

2. A book as recited in claim 1, in which:
the fundamental element is a letter; and
at least one of the images associated with the element is a pictorial image of an object whose name is spelled using the letter.

3. A book as recited in claim 1, in which:
the fundamental element is a letter; and
at least one of the images associated with the element is a printed word that is spelled using the letter, and the letter appears in an emphasized form over other letters used in the printed word.

4. A book as recited in claim 1, in which:
the fundamental element is a letter; and
at least one of the images associated with the element includes both a pictorial image of an object whose name is spelled using the letter and a printed word that is spelled using the letter, the letter appearing in an emphasized form over other letters in the printed word.

5. A book as recited in claim 1, in which:
the fundamental element is a number; and
at least one of the images associated with the element is a pictorial image of a group of that number of objects.

6. A book as recited in claim 1, in which:
the fundamental element is a color; and
at least on of the images associated with the element is a pictorial image of an object that has that color.

7. A book as recited in claim 1, in which substantially all of the internal pages bear an image associated with the element.

8. A collection of books as recited in claim 1.

9. A collection of books that has:
a first book that has;
a front cover that bears a single fundamental element;
a back cover;
internal pages that are positioned between the front cover and the back cover and bear images that are associated with the element on the cover;
a spine that joins one edge of the front cover, one edge of the back cover, and one edge of the internal pages;
a flap that is attached to a fore-edge side of one of the covers; and
magnetically-attracting elements in both the spine and the flap; and a second book that has:
a separate front cover that bears a different fundamental element;
a separate back cover;
separate internal pages that are positioned between the separate front cover and the separate back cover and bear images that are associated with the different element on the cover of the second book;
a separate spine that joins one edge of the separate front cover, one edge of the separate back cover, and one edge of the separate internal pages;
a separate flap that is attached to a separate fore-edge side of one of the separate covers; and
separate magnetically attracting elements in both the separate spine and the separate flap, the magnetically attracting elements in the two books enabling the books to hold together in a side-by-side relationship with the spine of one book adjacent the fore-edge of the other book.

10. A collection of books as recited in claim 9, in which:
the fundamental element and the different fundamental element are both letters; and
the collection includes a separate book for substantially each of the letters of the alphabet, each of the books having its own set of magnetically attracting elements.

11. A collection of books as recited in claim 9, in which:
the fundamental element and the different fundamental element are both numbers; and
the collection includes a separate book for substantially each integer from 1 to 9, each of the books having its own set of magnetically attracting elements.

12. A collection of books as recited in claim 9, in which: the fundamental element and the different fundamental element are both colors; and
the collection includes a separate book for at least three different colors, each of the books having its own set of magnetically attracting elements.

13. A collection of books as recited in claim 9, in which:
the fundamental element and the different fundamental element are both letters; and
at least one of the images associated with the letter on the cover is a pictorial image of an object whose name is spelled using the letter.

14. A collection of books as recited in claim 9, in which:
the fundamental element and the different fundamental element are both letters; and
at least one of the images in both the first book and in the second book is a printed word that is spelled using the letters of both books.

15. A collection of books as recited in claim 9, in which:
the fundamental element and the different fundamental element are both letters; and
at least one of the images associated with the fundamental element in the first book includes both a pictorial image of an object whose name is spelled using the letter and a printed word that is spelled using the letter, the letter appearing in an emphasized form over other letters in the printed word.

16. A collection of books as recited in claim 9, in which:
the fundamental element and the different fundamental element are both numbers; and
at least one of the images associated with the element of the first book is a pictorial image of a group of that number of objects.

17. A collection of books as recited in claim 9, in which:
the fundamental element and the different fundamental element are both colors; and
at least one of the images associated with the element of the first book is a pictorial image of an object that has that color.

18. A collection of books as recited in claim 9, in which:
substantially all of the internal pages in the first book bear an image associated with the fundamental element that appears on the cover of the first book.

19. A collection of books as recited in claim 9, in which the different fundamental element is a short combination of letters.
